(19) United States
(12) Patent Application Publication
(10) Pub. No.: US 2024/0308180 A1
(43) Pub. Date: Sep. 19, 2024

(54) VENTING AND FILTERING COMPONENTS FOR ENCAPSULATED THERMAL BARRIERS

(71) Applicant: Aspen Aerogels, Inc., Northborough, MA (US)

(72) Inventors: John Williams, Groton, MA (US); Owen Evans, Chelmsford, MA (US); David Mihalcik, Northborough, MA (US); George Gould, Mendon, MA (US); Kathryn deKrafft, Hudson, MA (US); David Baur, Ashland, MA (US)

(21) Appl. No.: 18/571,182

(22) PCT Filed: Jul. 1, 2022
(86) PCT No.: PCT/US2022/073369

§ 371 Date: Dec. 15, 2023

Related U.S. Application Data
(60) Provisional application No. 63/311,299, filed on Feb. 17, 2022.
(60) Provisional application No. 63/218,205, filed on Jul. 2, 2021.

(51) Int. Cl. B32B 7/12; B32B 3/26; B32B 5/02; B32B 5/18; B32B 27/06; H01M 10/651; H01M 10/658; H01M 50/204

(52) U.S. Cl. CPC B32B 7/12; B32B 3/266; B32B 5/022; B32B 5/024; B32B 5/18; B32B 27/065; H01M 10/651; H01M 10/658; H01M 50/204; B32B 2260/046; B32B 2266/126; B32B 2307/304; B32B 2307/7242; B32B 2457/10; B32B 2605/00; H01M 2220/20

(57) ABSTRACT

The present disclosure relates to materials and systems to manage thermal runaway issues in energy storage systems. Exemplary embodiments include an insulation layer that is encapsulated to form an insulation barrier. A particle capture layer is included in the insulation barrier. The particle capture layer captures particles released from the insulation barrier during compression of the insulation barrier.

### CROSS REFERENCES TO RELATED APPLICATIONS

This application claims priority to U.S. Provisional Patent Application No. 63/218,205, filed Jul. 2, 2021, and entitled “Materials, Systems, and Methods for Mitigation of Electrical Energy Storage Thermal Events” and to U.S. Provisional Patent Application No. 63/311,299, filed Feb. 17, 2022, and entitled “Venting and Filtering Components for a Battery Barrier” each of which is herein incorporated by reference in its entirety.

### FIELD OF THE TECHNOLOGY

The present disclosure relates generally to materials, systems, and methods for venting and filtering of battery modules or battery packs. In particular, the present disclosure relates to materials, systems and methods of providing filtered vents to allow gas to escape though an insulation barrier while particulate matter in the released gases is captured.

### BACKGROUND

Rechargeable batteries such as lithium-ion batteries have found wide application in the power-driven and energy storage systems. Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged (being charged beyond the designed voltage), over-discharged, or operated at or exposed to high temperature and high pressure. As a consequence, narrow operational temperature ranges and charge/discharge rates are limitations on the use of LIBs, as LIBs may fail through a rapid self-heating or thermal runaway event when subjected to conditions outside of their design window.

Thermal runaway may occur when the internal reaction rate increases to the point that more heat is being generated than can be withdrawn, leading to a further increase in both reaction rate and heat generation. During thermal runaway, high temperatures trigger a chain of exothermic reactions in a battery, causing the battery's temperature to increase rapidly. In many cases, when thermal runaway occurs in one battery cell, the generated heat quickly heats up the cells in close proximity to the cell experiencing thermal runaway. Each cell that is added to a thermal runaway reaction contains additional energy to continue the reactions, causing thermal runaway propagation within the battery pack, eventually leading to a catastrophe with fire or explosion. Prompt heat dissipation and effective block of heat transfer paths can be effective countermeasures to reduce the hazard caused by thermal runaway propagation.

Based on the understanding of the mechanisms leading to battery thermal runaway, many approaches are being studied, with the aim of reducing safety hazards through the rational design of battery components. To prevent such cascading thermal runaway events from occurring, LIBs are typically designed to either keep the energy stored sufficiently low, or employ thermal barriers between cells within the battery module or pack to insulate them from thermal events that may occur in an adjacent cell, or a combination thereof. The former severely limits the amount of energy that could potentially be stored in such a device. The latter limits how close cells can be placed and thereby limits the effective energy density.

Acrogel materials have been used as thermal barrier materials. Acrogel thermal barriers offer numerous advantages over other thermal barrier materials. Some of these benefits include favorable resistance to heat propagation and fire propagation while minimizing thickness and weight of materials used. Aerogel thermal barriers also have favorable properties for compressibility, compressional resilience, and compliance. Some aerogel based thermal barriers, due to their light weight and low stiffness, can be difficult to install between battery cells, particularly in a mass production setting. Furthermore, aerogel thermal barriers tend to produce particulate matter (dust) that can be detrimental to the electrical storage systems, creating manufacturing problems.

To mitigate the problems associated with handling of aerogel materials, acrogel thermal barriers can be encapsulated. Encapsulation materials used to encapsulate aerogel thermal barriers typically create a gas tight seal around the thermal barrier and prevent the release of particulate matter from the insulation barrier.

### SUMMARY

It is an object of the present disclosure to obviate or mitigate at least one disadvantage of previous methods and materials mentioned above. The insulation barriers provided herein are designed to improve encapsulation and handling of thermal barriers used in battery modules or battery packs.

In an aspect of the present disclosure, an insulation barrier for use in an electrical energy storage system comprises: at least one insulation layer; an encapsulation layer at least partially surrounding the insulation layer, the encapsulation layer comprising one or more openings; and a particle capture layer coupled to the encapsulation layer. Particles and gases produced during compression of the insulation barrier flow toward the one or more openings of the encapsulation layer. The particles and gases flow through the particle capture layer where at least a portion of the particles are retained in the particle capture layer.

In an aspect of the disclosure, the particle capture layer is positioned on an exterior surface of the encapsulation layer over the one or more openings. Particles produced during compression of the insulation barrier pass through the one or more openings of the encapsulation layer and are at least partially retained within the particle capture layer.

In an aspect of the disclosure, the encapsulation layer has an elongated opening. The encapsulation layer partially covers the insulation layer such that the elongated opening in the encapsulation layer is positioned along a side of the insulation layer. The particle capture layer is coupled to the encapsulation layer such that the particle capture layer is positioned over the elongated opening in the encapsulation layer.

In an aspect of the disclosure, the encapsulation layer has a plurality of openings positioned along one or more sides of the insulation layer. The particle capture layer is coupled to the encapsulation layer such that the particle capture layer is positioned over the plurality of openings in the encapsulation layer.

In some aspects of the disclosure, the particle capture layer is coupled to the encapsulation layer by an adhesive material. The adhesive material is positioned proximate to openings in the encapsulation layer such that the adhesive material acts as a barrier to the flow of the particles and gas directing the particles and gas into the particle capture layer.

In an aspect of the disclosure, the particle capture layer is positioned inside of the encapsulation layer. During use, particles and gases produced during compression of the insulation barrier pass into the particle capture layer before passing through one or more openings of the encapsulation layer and are at least partially retained within the particle capture layer.

The particle capture layer may be a foam material, a woven material, a non-woven material, or a webbed material.

In an aspect of the disclosure, the insulation barrier includes one or more polymer films coupled to the particle capture layer. The polymer films inhibit and/or capture particles during compression of the insulation barrier. The one or more of the polymer films may be in the form of a filter that inhibits the flow of particles through the polymer film and allows the passage of gases through polymer film. In an aspect of the disclosure, one of the polymer films covers a portion of the particle capture layer opposite the insulation layer. In another aspect of the disclosure, one of the polymer films covers a portion of the insulation layer and the particle capture layer.

In an aspect of the disclosure, the insulation layer has a thermal conductivity through a thickness dimension of said insulation layer of less than about 50 mW/m-K at 25° C. and less than about 60 mW/m-K at 600° C. In an aspect of the disclosure, the insulation layer comprises an aerogel.

In an aspect of the disclosure, the insulation layer comprises an aerogel material.

In an aspect of the disclosure, the encapsulation layer comprises a polymeric material. In some aspects of the disclosure, the encapsulation layer comprises a polymeric material and a metal layer embedded in the polymeric material.

In another aspect of the present disclosure, a battery module comprises a plurality of battery cells and one or more insulation barriers, as described herein, disposed between adjacent battery cells.

In another aspect, provided herein is a device or vehicle including the battery module or pack according to any one of the above aspects. In some embodiments, said device is a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. In some embodiments, the vehicle is an electric vehicle.

The insulation barrier described herein can provide one or more advantages over existing thermal runaway mitigation strategies. The insulation barrier described herein can minimize or eliminate cell thermal runaway propagation without significantly impacting the energy density of the battery module or pack and assembly cost. The insulation barrier of the present disclosure can provide favorable properties for compressibility, compressional resilience, and compliance to accommodate swelling of the cells that continues during the life of the cell while possessing favorable thermal properties under normal operation conditions as well as under thermal runaway conditions. The insulation barriers described herein are durable and easy to handle, have favorable resistance to heat propagation and fire propagation while minimizing thickness and weight of materials used, and also have favorable properties for compressibility, compressional resilience, and compliance.

### BRIEF DESCRIPTION OF THE DRAWINGS

Having thus described the disclosure in general terms, reference will now be made to the accompanying drawings, which are not necessarily drawn to scale, and wherein:

FIGS. 1A and 1B are projection views of an insulation barrier having a particle capture layer coupled to a side of an insulation layer;

FIGS. 2A and 2B are projection views of an insulation barrier having a particle capture layer coupled to a side of an insulation layer partially covered by an encapsulation layer;

FIG. 3 is a projection view of an insulation barrier having a particle capture layer coupled to a side of an insulation layer, with the particle capture layer encapsulated with the insulation layer;

FIG. 4 depicts an end and side view of an insulation barrier having an encapsulated insulation layer with a particle capture layer coupled to a side wall of the insulation layer.

FIG. 5 depicts a projection view of an insulation barrier having polymer film filter layers;

FIG. 6 depicts a schematic diagram of an insulation barrier having a particle capture layer encapsulated with the insulation layer and one or more openings in the encapsulation layer that allow gases to pass out of the insulation barrier.

FIG. 7 depicts a schematic diagram of an insulation barrier having an encapsulated insulation layer with a particle capture layer coupled to the encapsulation layer through an adhesive;

FIG. 8 depicts an alternate schematic diagram of an insulation barrier having an encapsulated insulation layer with a particle capture layer coupled to the encapsulation layer through an adhesive; and

FIG. 9 depicts a schematic diagram of a battery module having insulation barriers between battery cells.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

In the following detailed description of the preferred embodiments, reference is made to the accompanying drawings, which form a part thereof, and within which are shown by way of illustration specific embodiments by which the disclosure may be practiced. It is to be understood that other embodiments may be utilized and structural changes may be made without departing from the scope of the disclosure.

The present disclosure is directed to an insulation barrier and systems including insulation barriers to manage thermal runaway issues in energy storage systems. Exemplary embodiments include an insulation barrier comprising at least one insulation layer and an encapsulation layer at least partially surrounding the insulation layer.

An insulation layer may include any kind of insulation layer commonly used to separate battery cells or battery modules. Exemplary insulation layers include, but are not limited to, polymer based thermal barriers (e.g., polypropylene, polyester, polyimide, and aromatic polyamide (aramid)), phase change materials, intumescent materials, acrogel materials, mineral based barrier (e.g., mica), and inorganic thermal barriers (e.g., fiberglass containing barriers).

In a preferred embodiment, the insulation layer comprises an acrogel material. A description of an acrogel insulation layer is described in U.S. Patent Application Publication No. 2021/0167438 and U.S. Provisional Patent Application No. 63/218,205, both of which are incorporated herein by reference.

The insulation layer can have a thermal conductivity through a thickness dimension of said insulation layer about 50 mW/mK or less, about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values at 25° C. under a load of up to about 5 MPa.

Insulation layers can have a number of different physical properties that make it difficult to incorporate the insulation layers into a battery module or battery pack. For example, some insulation layers have very low flexural modulus (e.g., less than 10 MPa), making the materials difficult to handle and position between battery cells. Additionally, a low flexural modulus material can be difficult to manipulate, particularly if using an automated encapsulation process. Some insulation layers tend to produce particulate matter (dust) that can be detrimental to the electrical storage systems, creating manufacturing problems.

These problems can be mitigated by using an encapsulation layer. The encapsulation layer surrounds at least a portion of the insulation layer such that the encapsulation layer inhibits or prevents particulate matter from being released into a battery module or battery pack. The encapsulation layer is typically sealed around the insulation layer so that particles and gases cannot enter or exit the encapsulation layer. During compression of the encapsulation layer, the encapsulation layer could rupture or leak releasing particles and gas into the battery module. To mitigate this problem, modifications may be made to the encapsulation layer. The first modification is that one or more openings are provided in the encapsulation layer. These openings provide a flow path through which gas and particles can exit the encapsulation layer. The second modification is to couple a particle capture layer to the encapsulation layer. Particles and gas produced during compression of the insulation barrier will flow toward the one or more openings of the encapsulation layer and any particulate matter flowing with the gas is at least partially retained within the particle capture layer.

The encapsulation layer is a single layer or multiple layers of material. The encapsulation layer can be in the form of a film, an envelope, or a bag. The encapsulation layer can be made of any material that is suitable to enclose the insulation layer. Materials used to form the encapsulation layer can be selected from a polymer, an elastomer or combination thereof. Examples of suitable polymers such as polyethylene terephthalate (PET), polyethylene (PE), polyimide (PI), polypropylene, polyamide, rubber, and nylon, have very low thermal conductivity (less than 1 W/m) which has the effect of lowering the overall system through-plane thermal conductivity. In one embodiment, the encapsulation layer comprises polyethylene terephthalate polymer.

In another embodiment, the encapsulation layer is composed of multiple layers of material. For example, a multilayer material, similar to materials used to form a pouch battery cell case may be used. In one embodiment, the encapsulation layer comprises a laminate comprising three layers: a first polymer layer, a second thermally conductive layer, and a third polymer layer, with the thermally conductive layer sandwiched between the first and third polymer layers. The first and third polymer layers are preferably formed from a polymer having a very low thermal conductivity (less than 1 W/m). Examples of polymers that can be used for the first and third polymer layers include, but are not limited to, polyethylene terephthalate (PET), polyethylene (PE), polypropylene, polyamide, and nylon. Examples of thermally conductive materials that can be used in the second layer include, but are not limited to, metals (e.g., copper, stainless steel, or aluminum), carbon fibers, graphite, and silicon carbides. When a metal thermally conductive layer is used, the metal may be in the form of a foil that is sandwiched between the polymer layers.

In another embodiment, the encapsulation layer comprises a laminate comprising three layers: a first polymer layer, a second flame resistant layer, and a third polymer layer, with the flame resistant layer sandwiched between the first and third polymer layers. The first and third polymer layers are preferably formed from a polymer having a very low thermal conductivity (less than 1 W/m) as discussed previously. Examples of flame resistant materials that can be used in the second layer include, but are not limited to, metals (e.g., copper, stainless steel, or aluminum), mica, polybenzimidazole fiber (PBI fiber), coated nylon, melamine, modacrylic, and aromatic polyamide (aramid). When a metal thermally conductive layer is used, the metal may be in the form of a foil that is sandwiched between the polymer layers.

Metals are a preferred material for use in a laminate encapsulating layer. Metals provide both thermally conductive properties and flame resistance to the encapsulation layer. By using a single material to provide both flame resistance and thermal conductivity, the thickness of the encapsulating layer can be minimized.

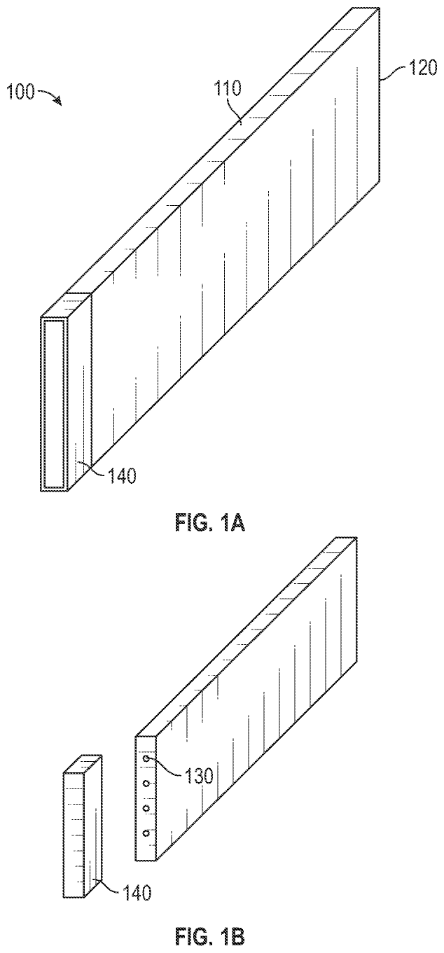

An embodiment of an insulation barrier comprising a particle capture layer is depicted in FIGS. 1A and 1B. Insulation barrier 100 includes an insulation layer 110. Insulation layer 110 is surrounded by encapsulation layer 120. As shown in FIG. 1B one or more openings 130 may be formed in encapsulation layer 120. A particle capture layer 140 is coupled to the encapsulation layer 120. In this embodiment, particle capture layer 140 is positioned on an exterior surface of encapsulation layer 120 over the one or more openings. During compression of the insulation barrier particles and gas flow toward one or more of the openings of the encapsulation layer. As the particles and gas pass through the openings, the gas and particles pass into the particle capture layer, where at least a portion of the particles are retained within the particle capture layer. In this, and any other embodiment, it should be understood that while the particle capture layer is depicted as being positioned on an end of the insulation layer, the particle capture layer, and the openings in the encapsulation layer, can be positioned along any side of the insulation layer (i.e., the top side, the bottom side, the front sidewall, the rear sidewall, the front end and the back end).

A particle capture layer, as used herein, refers to a layer of material that can trap particles that impinge on the material. Examples of materials used for the particle capture layer include, but are not limited to, foam (open cell or closed cell), woven materials, non-woven materials (e.g., felt, batting, matted fabric), or a webbed material. Generally, the particle capture layer is made from a material that allows gas to pass through the material, while particles are retained in the particle capture layer.

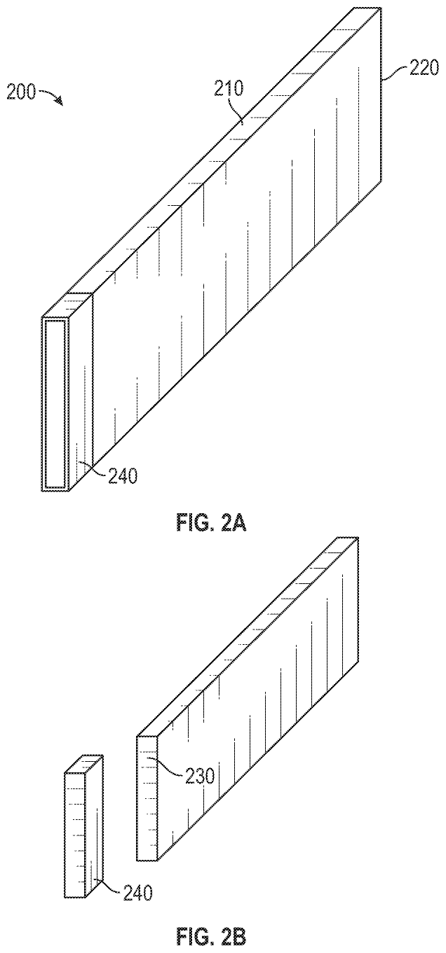

An embodiment of an insulation barrier comprising a particle capture layer is depicted in FIGS. 2A and 2B. Insulation barrier 200 includes an insulation layer 210. Insulation layer 210 is surrounded by encapsulation layer 220. As shown in FIG. 2B the encapsulation layer is not fully sealed along a side of the insulation layer. In this manner, a single elongated opening 230 along the entire side of the insulation layer is formed. A particle capture layer 240 is coupled over the elongated opening 230. In this embodiment, particle capture layer 240 is positioned on an exterior surface of insulation layer 210. During compression of the insulation barrier particles and gas flow toward the elongated opening of the encapsulation layer. As the particles and gas pass through the opening, the gas and particles pass into the particle capture layer, where at least a portion of the particles are retained within the particle capture layer.

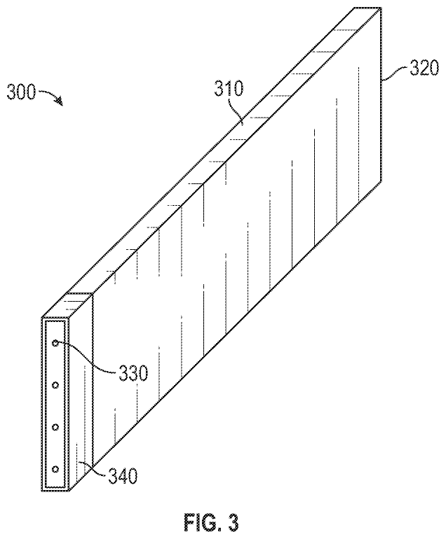

Another embodiment of an insulation barrier comprising a particle capture layer is depicted in FIG. 3. Insulation barrier 300 includes an insulation layer 310. Insulation layer 310 is surrounded by encapsulation layer 320. One or more openings 330 may be formed in encapsulation layer 320. A particle capture layer 340 is coupled to the encapsulation layer 320. In this embodiment, particle capture layer 340 is positioned between insulation layer 310 and encapsulation layer 320 in fluid contact with the one or more openings. During compression of the insulation barrier particles and gas flow toward one or more of the openings of the encapsulation layer. As the particles and gas pass toward the openings, the gas and particles pass into the particle capture layer, where at least a portion of the particles are retained within the particle capture layer. The gas continues through particle capture layer 340 and out through openings 330. Particles are substantially retained in the particle capture layer as the gas passes through the material.

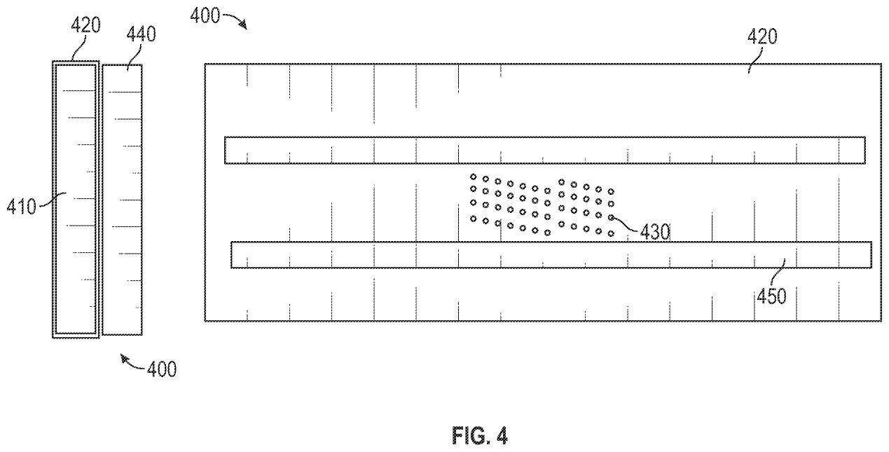

Another embodiment of an insulation barrier comprising a particle capture layer is depicted in FIG. 4. Insulation barrier 400 includes an insulation layer 410. Insulation layer 410 is surrounded by encapsulation layer 420. One or more openings 430 may be formed in a side wall of encapsulation layer 420. A particle capture layer 440 is attached to the encapsulation layer 420 using an adhesive 450 (e.g., adhesive strips). In this embodiment, particle capture layer 440 is positioned over the openings formed in the encapsulation layer. During compression of the insulation barrier particles and gas flows toward one or more of the openings of the encapsulation layer. As the particles and gas pass through the openings 430, the gas and particles pass into the particle capture layer 440, where at least a portion of the particles are retained within the particle capture layer. Particles are substantially retained in the particle capture layer as the gas passes through the material.

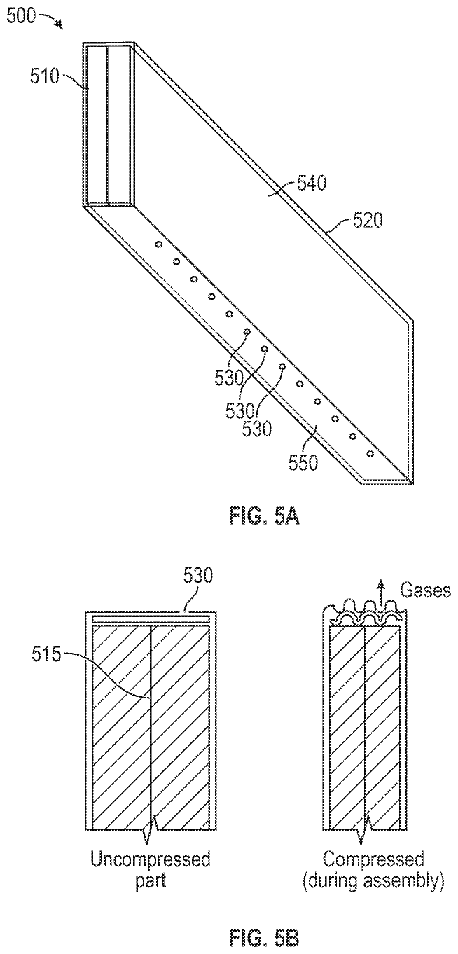

Another embodiment of an insulation barrier comprising a particle capture layer is depicted in FIG. 5A and 5B. Insulation barrier 500 includes an insulation layer 510. A particle capture layer 540 is coupled to insulation layer 510. In some embodiments, a first polymer film 515 is positioned between the insulation layer and the particle capture layer. Insulation layer 510, first polymer film 515, and particle capture layer 540 are surrounded by encapsulation layer 520. One or more openings 530 may be formed in encapsulation layer 520. A second polymer film 550 is coupled to particle capture layer 540 and positioned between the insulation layer 510, the particle capture layer 540, and the openings 530. The first and second polymer films may be in the form of a filter that allows gases to pass through the film, but inhibits the progress of particles through the film. Examples of polymeric materials that may be used are polyethylene terephthalate (PET) and polypropylene (PP). The first and second polymer films are thin films (e.g., a polymer film having a thickness less than 1 mm). During compression of the insulation barrier particles and gas flow toward one or more of the openings of the encapsulation layer. The first and second polymer films act as filters that capture at least a portion of the particles as the particles are pushed toward the openings. The gas continues through particle capture layer 540 and out through openings 530. Particles are substantially retained in the particle capture layer as the gas passes through the material.

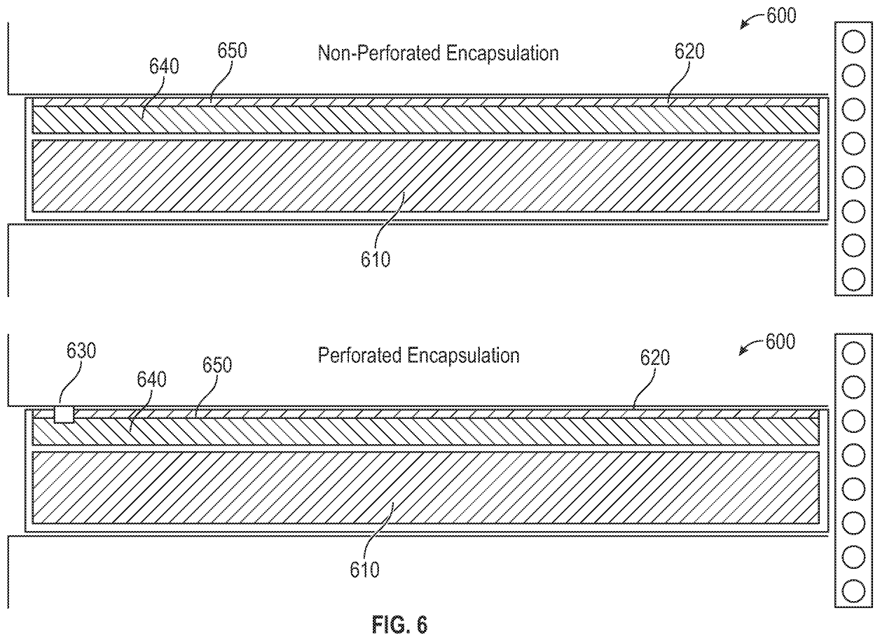

Another embodiment of an insulation barrier comprising a particle capture layer is depicted in FIG. 6. Insulation barrier 600 includes an insulation layer 610. A particle capture layer 640 is coupled to insulation layer 610. A polymer film 650 is coupled to particle capture layer 640. Insulation layer 610, polymer film 650, and particle capture layer 640 are surrounded by encapsulation layer 620. One or more openings 630 are formed in encapsulation layer 620. Polymer film 650 is positioned between particle capture layer 640 and one or more openings 630. Polymer film 650 may be impervious to the passage of gases and particles. During compression of the insulation barrier particles and gas flow toward one or more of the openings of the encapsulation layer. The barrier properties of polymer film 650 directs gases and particles that enter the particle capture layer further away from the openings through the particle capture layer before the gases exit through openings 630. By creating an extended flow path through the particle capture material, the particle capture efficiency is improved.

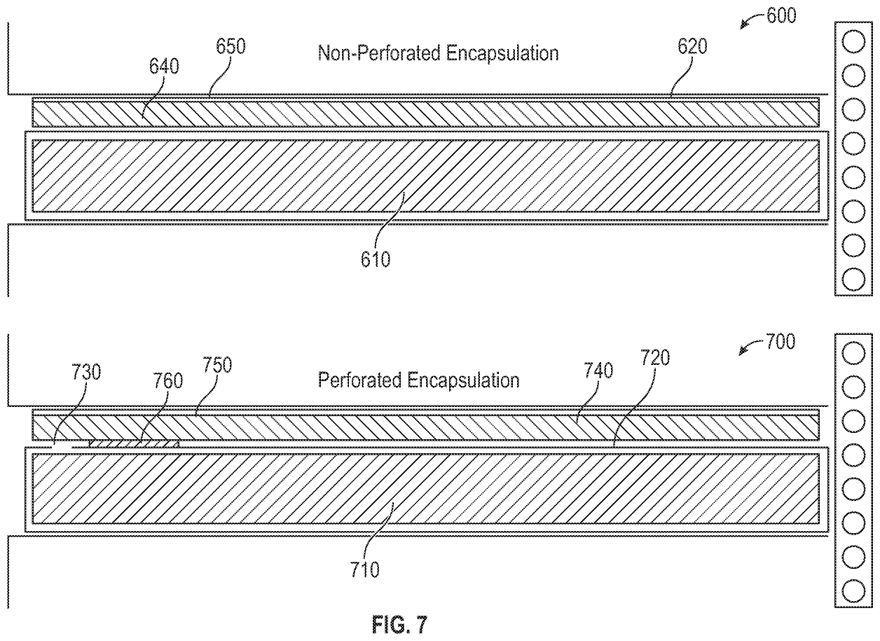

Another embodiment of an insulation barrier comprising a particle capture layer is depicted in FIG. 7. Insulation barrier 700 includes an insulation layer 710. Insulation layer 710 is surrounded by encapsulation layer 720. A particle capture layer 740 is coupled to the insulation layer 710 by attaching the particle capture layer to the encapsulation layer using an adhesive 760 (e.g., an adhesive strip or adhesive pad). A polymer film 750 is coupled to particle capture layer 740. One or more openings 730 are formed in encapsulation layer 720. Polymer film 750 is positioned on the side of the particle capture layer 740 opposite to the insulation layer 710. Polymer film 750 may be impervious to the passage of gases and particles. During compression of the insulation barrier particles and gas flow toward and through one or more of the openings of the encapsulation layer, as depicted in FIG. 7. The barrier properties of polymer film 750 directs gases and particles through the particle capture layer before the gases exit through the particle capture layer. Adhesive 760 creates an additional barrier to the flow of particles and gases. Adhesive 760 directs the particles and gases that escape the encapsulation layer into the particle capture layer. By creating a directed flow path through the particle capture material, the particle capture efficiency is improved.

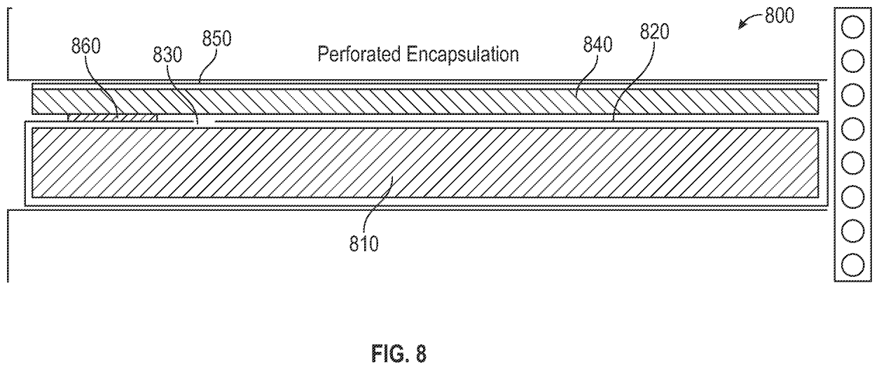

Another embodiment of an insulation barrier comprising a particle capture layer is depicted in FIG. 8. Insulation barrier 800 includes an insulation layer 810. Insulation layer 810 is surrounded by encapsulation layer 820. A particle capture layer 840 is coupled to the insulation layer 810 by attaching the particle capture layer to the encapsulation layer using an adhesive 860 (e.g., an adhesive strip or adhesive pad). A polymer film 850 is coupled to particle capture layer 840. One or more openings 830 are formed in encapsulation layer 820. Polymer film 850 is positioned on the side of the particle capture layer 840 opposite to the insulation layer 810. Polymer film 850 may be impervious to the passage of gases and particles. During compression of the insulation barrier particles and gas flow toward and through one or more of the openings of the encapsulation layer, as depicted in FIG. 8. The barrier properties of polymer film 850 directs gases and particles through the particle capture layer before the gases exit through the particle capture layer. Adhesive 860 creates an additional barrier to the flow of particles and gases. Adhesive 860 directs the particles and gases further into the particle capture layer, proving a longer flow path for capture of the particles. By creating a directed flow path through the particle capture material, the particle capture efficiency is improved.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

Within the context of the present disclosure, the term “aerogel”, “aerogel material” or “acrogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to acrogels: (a) an average pore diameter ranging from about 2 nm to about 100 nm, (b) a porosity of at least 80% or more, and (c) a surface area of about 100 m²/g or more.

Acrogel materials of the present disclosure thus include any acrogels or other open-celled materials which satisfy the defining elements set forth in previous paragraphs; including materials which can be otherwise categorized as xerogels, cryogels, ambigels, microporous materials, and the like.

Within the context of the present disclosure, references to “thermal runaway” generally refer to the sudden, rapid increase in cell temperature and pressure due various operational factors and which in turn can lead to propagation of excessive temperature throughout an associated module. Potential causes for thermal runaway in such systems may, for example, include: cell defects and/or short circuits (both internal and external), overcharge, cell puncture or rupture such as in the event of an accident, and excessive ambient temperatures (e.g., temperatures typically greater than 55° C.). In normal use, the cells heat as result of internal resistance. Under normal power/current loads and ambient operating conditions, the temperature within most Li-ion cells can be relatively easily controlled to remain in a range of 20° C. to 55° C. However, stressful conditions such as high power draw at high cell/ambient temperatures, as well as defects in individual cells, may steeply increase local heat generation. In particular, above the critical temperature, exothermic chemical reactions within the cell are activated. Moreover, chemical heat generation typically increases exponential with temperature. As a result, heat generation becomes much greater than available heat dissipation. Thermal runaway can lead to cell venting and internal temperatures in excess of 200° C.

Within the context of the present disclosure, the terms “thermal conductivity” and “TC” refer to a measurement of the ability of a material or composition to transfer heat between two surfaces on either side of the material or composition, with a temperature difference between the two surfaces. Thermal conductivity is specifically measured as the heat energy transferred per unit time and per unit surface area, divided by the temperature difference. It is typically recorded in SI units as mW/m*K (milliwatts per meter*Kelvin). The thermal conductivity of a material may be determined by test methods known in the art, including, but not limited to Test Method for Steady-State Thermal Transmission Properties by Means of the Heat Flow Meter Apparatus (ASTM C518, ASTM International, West Conshohocken, PA); a Test Method for Steady-State Heat Flux Measurements and Thermal Transmission Properties by Means of the Guarded-Hot-Plate Apparatus (ASTM C177, ASTM International, West Conshohocken, PA); a Test Method for Steady-State Heat Transfer Properties of Pipe Insulation (ASTM C335, ASTM International, West Conshohocken, PA); a Thin Heater Thermal Conductivity Test (ASTM C1114, ASTM International, West Conshohocken, PA); Standard Test Method for Thermal Transmission Properties of Thermally Conductive Electrical Insulation Materials (ASTM D5470, ASTM International, West Conshohocken, PA); Determination of thermal resistance by means of guarded hot plate and heat flow meter methods (EN 12667, British Standards Institution, United Kingdom); or Determination of steady-state thermal resistance and related properties-Guarded hot plate apparatus (ISO 8203, International Organization for Standardization, Switzerland). Due to different methods possibly resulting in different results, it should be understood that within the context of the present disclosure and unless expressly stated otherwise, thermal conductivity measurements are acquired according to ASTM C518 standard (Test Method for Steady-State Thermal Transmission Properties by Means of the Heat Flow Meter Apparatus), at a temperature of about 37.5° C. at atmospheric pressure in ambient environment, and under a compression load of about 2 psi. The measurements reported as per ASTM C518 typically correlate well with any measurements made as per EN 12667 with any relevant adjustment to the compression load.

Thermal conductivity measurements can also be acquired at a temperature of about 10° C. at atmospheric pressure under compression. Thermal conductivity measurements at 10° C. are generally 0.5-0.7 mW/mK lower than corresponding thermal conductivity measurements at 37.5° C. In certain embodiments, the insulation layer of the present disclosure has a thermal conductivity at 10°° C. of about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values.

Use of the Insulation Barriers within Battery Module or Pack

Lithium-ion batteries (LIBs) are considered to be one of the most important energy storage technologies due to their high working voltage, low memory effects, and high energy density compared to traditional batteries. However, safety concerns are a significant obstacle that hinders large-scale applications of LIBs. Under abuse conditions, exothermic reactions may lead to the release of heat that can trigger subsequent unsafe reactions. The situation worsens, as the released heat from an abused cell can activate a chain of reactions, causing catastrophic thermal runaway.

With continuous improvement of LIBs in energy density, enhancing their safety is becoming increasingly urgent for the development of electrical devices e.g. electrical vehicles. The mechanisms underlying safety issues vary for each different battery chemistry. The present technology focuses on tailoring insulation barrier and corresponding configurations of those tailored barriers to obtain favorable thermal and mechanical properties. The insulation barriers of the present technology provide effective heat dissipation strategies under normal as well as thermal runaway conditions, while ensuring stability of the LIB under normal operating modes (e.g., withstanding applied compressive stresses).

The insulation barriers disclosed herein are useful for separating, insulating and protecting battery cells or battery components of batteries of any configuration, e.g., pouch cells, cylindrical cells, prismatic cells, as well as packs and modules incorporating or including any such cells. The insulation barriers disclosed herein are useful in rechargeable batteries e.g. lithium-ion batteries, solid state batteries, and any other energy storage device or technology in which separation, insulation, and protection are necessary.

Passive devices such as cooling systems may be used in conjunction with the insulation barriers of the present disclosure within the battery module or battery pack.

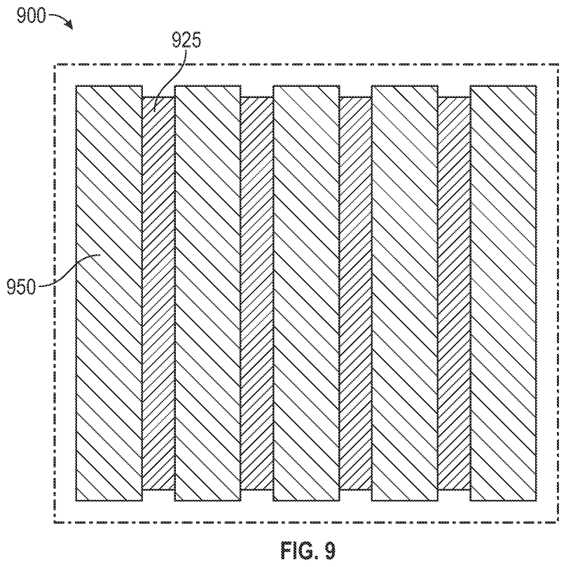

The insulation barrier according to various embodiments of the present disclosure in a battery pack including a plurality of single battery cells or of modules of battery cells for separating said single battery cells or modules of battery cells thermally from one another. A battery module is composed of multiple battery cells disposed in a single enclosure. A battery pack is composed of multiple battery modules. FIG. 9 depicts an embodiment of a battery module 900 having a plurality of battery cells 950. Encapsulated insulation barriers 925 are positioned between battery cells 950. The encapsulated insulation barrier can inhibit or prevent damage of adjacent battery cells when a battery cell undergoes thermal runaway or any other catastrophic batter cell failure.

Battery modules and battery packs can be used to supply electrical energy to a device or vehicles. Device that use battery modules or battery packs include, but are not limited to, a laptop computer, PDA, mobile phone, tag scanner, audio device, video device, display panel, video camera, digital camera, desktop computers military portable computers military phones laser range finders digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool. When used in a vehicle, a battery pack can be used for an all-electric vehicle, or in a hybrid vehicle.

In this patent, certain U.S. patents, U.S. patent applications, and other materials (e.g., articles) have been incorporated by reference. The text of such U.S. patents. U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. An insulation barrier for use in an electrical energy storage system, the insulation barrier comprising:
at least one insulation layer;
an encapsulation layer at least partially surrounding the insulation layer, the encapsulation layer comprising one or more openings; and
a particle capture layer coupled to the encapsulation layer and positioned between the at least one insulation layer and the encapsulation layer;
wherein particles and gas produced during compression of the insulation barrier flow toward the one or more openings of the encapsulation layer and wherein the particles are at least partially retained within the particle capture layer.

2. The insulation barrier of claim 1, wherein the particle capture layer is positioned on an exterior surface of the encapsulation layer over the one or more openings, and wherein particles produced during compression of the insulation barrier pass through the one or more openings of the encapsulation layer and are at least partially retained within the particle capture layer.

3. The insulation barrier of claim 2, wherein the encapsulation layer comprises an elongated opening, and wherein the encapsulation layer partially covers the insulation layer such that the elongated opening in the encapsulation layer is positioned along a side of the insulation layer, and wherein the particle capture layer is coupled to the encapsulation layer such that the particle capture layer is positioned over the elongated opening in the encapsulation layer.

4. The insulation barrier of claim 2, wherein the encapsulation layer comprises a plurality of openings positioned along one or more sides of the insulation layer, and wherein the particle capture layer is coupled to the encapsulation layer such that the particle capture layer is positioned over the plurality of openings in the encapsulation layer.

5. The insulation barrier of claim 3, wherein the particle capture layer is coupled to the encapsulation layer by an adhesive material.

6. The insulation barrier of claim 5, wherein the adhesive material is positioned proximate to the opening such that the adhesive material acts as a barrier to the flow of the particles and gas directing the particles and gas into the particle capture layer.

7. The insulation barrier of claim 1, wherein the particle capture layer is positioned inside of the encapsulation layer, and wherein, during use, particles and gasses produced during compression of the insulation barrier pass into the particle capture layer before passing through the one or more openings of the encapsulation layer and are at least partially retained within the particle capture layer.

8. The insulation barrier of claim 1, wherein the particle capture layer comprises a foam material.

9. The insulation barrier of claim 1, wherein the particle capture layer comprises a woven material, a non-woven material, or a webbed material.

10. The insulation barrier of claim 1, further comprising one or more polymer films coupled to the particle capture layer, wherein the polymer films inhibit and/or capture particles during compression of the insulation barrier.

11. The insulation barrier of claim 10, wherein one or more of the polymer films are in the form of a filter that inhibits the flow of particles through the polymer film and allows the passage of gases through polymer film.

12. The insulation barrier of claim 10, wherein one of the polymer films covers a portion of the particle capture layer opposite the insulation layer.

13. The insulation barrier of claim 10, wherein one of the polymer films covers a portion of the insulation layer and the particle capture layer.

14. The insulation barrier of claim 1, wherein the insulation layer has a thermal conductivity through a thickness dimension of said insulation layer of less than about 50 mW/m-K at 25° C. and less than about 60 mW/m-K at 600° C.

15. The insulation barrier of claim 1, wherein the insulation layer comprises an aerogel.

16. The insulation barrier of claim 1, wherein the encapsulation layer comprises a polymeric material.

17. The insulation barrier of claim 14, wherein the encapsulation layer comprises a polymeric material and a metal layer embedded in the polymeric material.

18. A battery module comprising:
a plurality of battery cells, and
one or more insulation barriers according to claim 17;, wherein at least one insulation barrier is disposed between adjacent battery cells.

19. An electrical power system comprising one or more battery modules as described in claim 18.

20. A device or vehicle comprising a battery module according to claim 18.

21. The device of claim 20, wherein said device is a laptop computer, PDA, mobile phone, tag scanner, audio device, video device, display panel, video camera, digital camera, desktop computers, military portable computers, military phones, laser range finders, digital communication device, intelligence gathering sensor, electronically integrated apparel, night vision equipment, power tool, calculator, radio, remote controlled appliance, GPS device, handheld and portable television, car starters, flashlights, acoustic devices, portable heating device, portable vacuum cleaner or a portable medical tool.

22. The vehicle of claim 20, wherein the vehicle is an electric vehicle.
